(19) United States
(12) Patent Application Publication
(10) Pub. No.: US 2010/0138612 A1
(43) Pub. Date: Jun. 3, 2010

(54) SYSTEM AND METHOD FOR IMPLEMENTING CACHE SHARING

(75) Inventor: Zhanming WEI, Haidian District (CN)

Correspondence Address: LADAS & PARRY LLP, 224 SOUTH MICHIGAN AVENUE, SUITE 1600, CHICAGO, IL, 60604, US

(73) Assignee: HANGZHOU H3C TECHNOLOGIES CO., LTD., Hangzhou City (CN)

(21) Appl. No.: 12/697,376

(22) Filed: Feb. 1, 2010

Related U.S. Application Data
(63) Continuation of application No. PCT/CN2008/001146, filed on Jun. 13, 2008.

(30) Foreign Application Priority Data
Aug. 1, 2007 (CN) 200710141550.5

(51) Int. Cl. G06F 12/08; G06F 12/00

(52) U.S. Cl. 711/130; 711/141; 711/E12.001; 711/E12.026; 711/E12.038

(57) ABSTRACT

A system for implementing cache sharing includes a main control unit and a plurality of service processing units, and further includes a shared cache unit respectively connected with the main control unit and the service processing units for implementing high-speed data interaction among the service processing units. A method for cache sharing is also provided. In embodiments of the present invention, based on a reliable high-speed bus, a high-speed shared cache is provided. A mutual exclusion scheme is provided in the shared cache to ensure data consistency, which not only implements high-speed data sharing but also dramatically improves system performance.

### FIELD OF THE INVENTION

The present invention relates to communication technologies, and more particularly, to a system and method for implementing cache sharing.

### BACKGROUND OF THE INVENTION

Conventionally, data systems are generally divided into centralized systems and distributed systems.

In a centralized system shown in FIG. 1, a main control unit as well as service processing units has its own memory unit adapted to store its data. Each service processing unit has an interface connected with its downlink device. The service processing units communicate with the main control unit through control channels of a switch network. The service processing units communicate with each other through service channels of the switch network.

In a distributed system as shown in FIG. 2, each service processing unit communicates with an interface through a service channel of the switch network. The service processing units and the interfaces are coupled to the main control unit through control channels of the switch network. Each of the service processing unit includes a control engine, a memory unit and a stream accelerating engine.

It can be seen from the above that, whether the centralized system or the distributed system, the memory unit is set inside each service processing unit and is dedicated to the corresponding service processing unit. The memory unit cannot provide a storage service for other service processing units. Therefore, there is a disadvantage that the service processing units cannot directly share data with other. At the same time, in order to realize data sharing between the service processing units, the data must be forwarded by the main control unit instead of direct data sharing. Thus, a reliability problem of the data transmission arises inevitably. Therefore, the data transmission at each time should be acknowledged. If the data transmission fails, re-transmission is required. This inevitably results in longer system delay and generates a system bottleneck or makes some data services requiring high speed and low latency inapplicable.

### SUMMARY OF THE INVENTION

Embodiments of the present invention provide a system and method for implementing cache sharing, which solves a problem that data cannot be directly shared among service processing units in the conventional art.

According to an embodiment of the present invention, a system for implementing cache sharing, including: a main controller, a plurality of service processing units, and a shared cache unit connected with the main control unit and the plurality of service processing units respectively;
wherein the main controller transfers control information to the plurality of service processing units through a control channel, and the plurality of the service processing units transfer service data between each other through a service channel; the main controller and the plurality of the service processing units are respectively configured with memories;
the shared cache unit is adapted to implement cache sharing and comprises:
a high-speed interface, respectively connected with the main control unit and the plurality of the service processing units, adapted to receive operation requests on the shared cache unit;
a high-speed cache, adapted to provide a cache space and store data at a high-speed; and
a cache controller, connected between the high-speed interface and the high-speed cache, adapted to: according to the operation requests on the shared cache unit, implement an operation on the high-speed cache to realize the cache sharing.

According to still another embodiment of the present invention, in a method for implementing cache sharing based on the above system, a first service processing unit initiates a message for allocating a cache space; the message includes: the first service processing unit and a second service processing unit which are members sharing the cache space, and a size of the cache space. The method includes:
after receiving the message, issuing, by the main controller to the shared cache unit, a command of allocating the cache space;
after receiving the command, transmitting, by the shared cache unit to the main controller, information of the cache space and reading and writing authorities of the members sharing the cache space;
obtaining, by the first service processing unit, a writing authority allocated to itself, writing data to be written into the cache space, and releasing the writing authority after finishing writing;
obtaining, by the second service processing unit, a reading authority allocated to itself, reading data from the cache space, and releasing the reading authority after finishing reading.

According to another embodiment of the present invention, a method for implementing cache sharing based on the above system includes:
when a writing request is writing into a cache space, forbidding other requests from reading from or writing into the cache space, and after a former writing request is terminated, allowing a subsequent request to read from or write into the cache space;
when a reading request is reading from the cache space, reading data from the cache space simultaneously according to each reading request, forbidding other requests from writing into the same cache space;
allowing a subsequent request to write into the cache space after reading operations corresponding to reading requests are terminated.

Compared with the conventional art, the embodiments of the present invention have the following advantages: through configuring the shared cache for the main control unit and the service processing units and providing the mutual exclusion scheme in the shared cache, the embodiments of the present invention ensure data consistency among the service processing units. In addition, high-speed data sharing is realized through allocating spaces in the shared cache, which dramatically improves the performance of the system.

### BRIEF DESCRIPTION OF THE DRAWINGS

FIG. 1 is a schematic diagram illustrating conventional distribution of dedicated memories in a centralized system.

FIG. 2 is a schematic diagram illustrating conventional distribution of dedicated memories in a distributed system.

FIG. 3 is a block diagram illustrating a centralized system adopting a shared cache unit according to an embodiment of the present invention.

FIG. 4 is a block diagram illustrating a distributed system adopting a shared cache unit according to an embodiment of the present invention.

FIG. 5 is a flowchart of collecting attack statistics using a cache sharing system according to an embodiment of the present invention.

FIG. 6 is a flowchart illustrating initialization of the cache sharing system according to an embodiment of the present invention.

FIG. 7 is a flowchart illustrating sharing data between service processing units using the cache sharing system according to an embodiment of the present invention.

FIG. 8 is a flowchart illustrating the implementation of an internal mutual exclusion scheme in a cache sharing unit according to an embodiment of the present invention.

FIG. 9 is a block diagram illustrating a cache sharing unit according to an embodiment of the present invention.

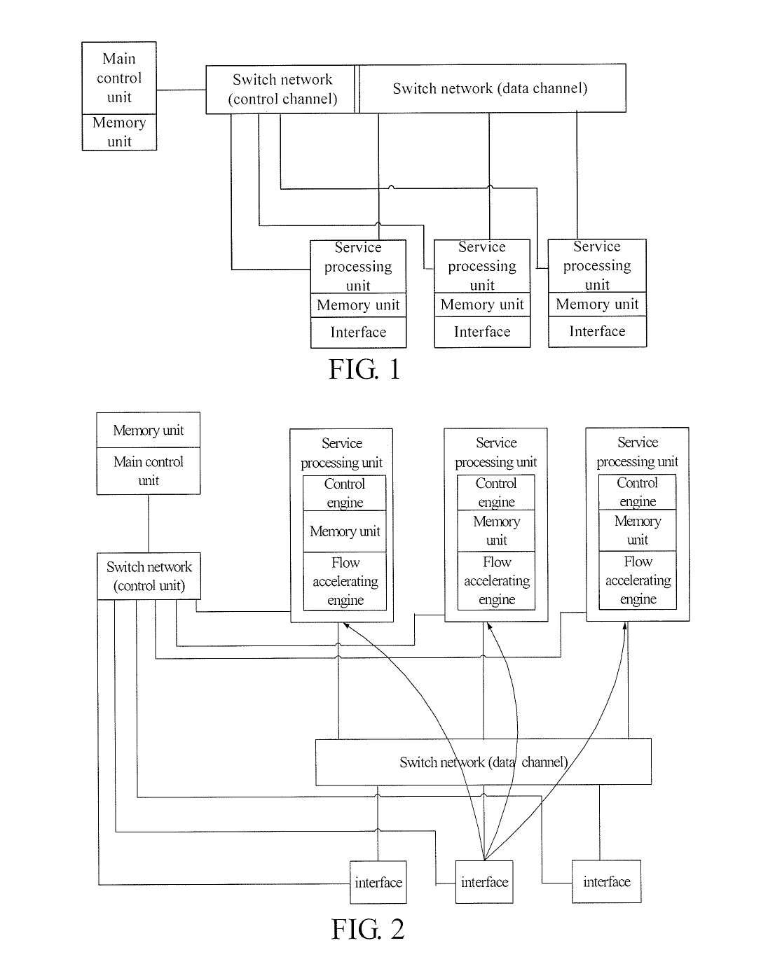

### DETAILED DESCRIPTION OF THE INVENTION

The present invention will be described in detail hereinafter with reference to accompanying embodiments. It should be noted that the following embodiments are only used for describing the present invention and are not used for restricting the protection scope of the present invention.

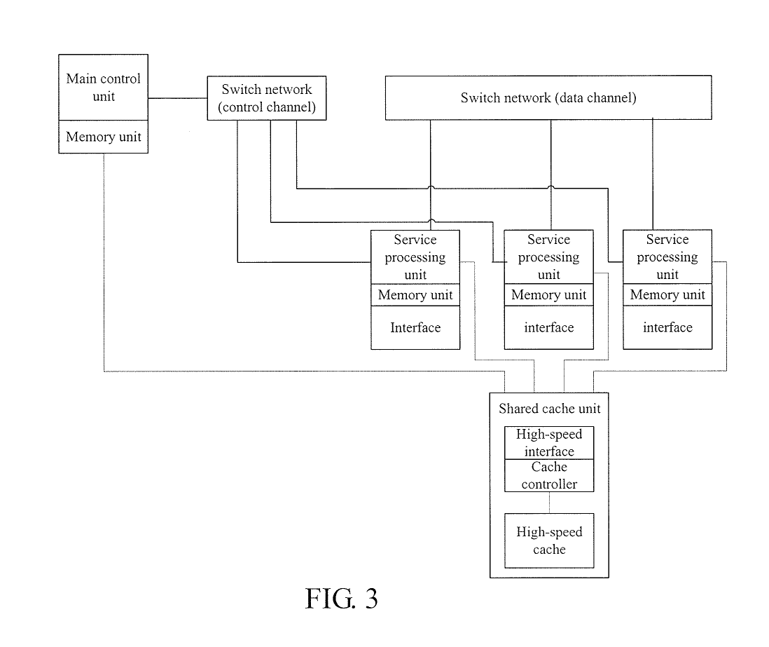

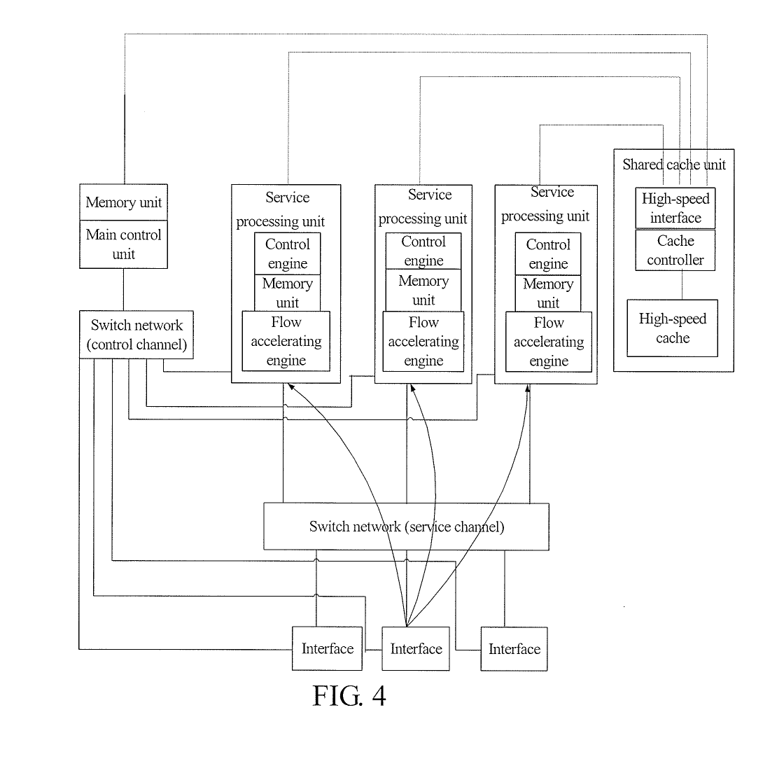

FIG. 3 shows a centralized system using a shared cache unit according to an embodiment of the present invention. FIG. 4 shows a distributed system using the shared cache unit according to another embodiment of the present invention. In particular, the shared cache unit includes: a high-speed interface, a cache controller and a high-speed cache. The high-speed interface should be based on a reliable connection, e.g. Peripheral Component Interconnect Express (PCIE), Hyper Transport (HT) and Rapid IO, so as to ensure the reliability of data transmission between the shared cache unit and the service processing units from a bottom layer. The cache controller is a core module of the shared cache unit and acts as a channel between the high-speed interface and the high-speed cache. The cache controller has main functions including: implementing address mapping between the high-speed interface and the high-speed cache, extending addressing space, extending cache space on demand, implementing mutual exclusion when different service processing units visit a same cache address, ensuring consistency of cache data, providing a cache automatic aging function through providing timers and configuring each timer. The high-speed cache is adapted to store data for the main control unit and the service processing units.

The cache sharing system provided by embodiments of the present invention may flexibly implement various functions. In a cache sharing method according to an embodiment, a shared cache is configured for the main control unit and a plurality of service processing units so as to provide a common storage space for the service processing units and to ensure data consistency between services processed by different service processing units. Hereinafter, the cache sharing method will be described with reference to an embodiment.

When setting up new connections, all service processing units or some service processing units are required to write in a same shared cache space. Thus, the mutual exclusion scheme has to be implemented in the cache controller.

The shared cache unit receives and parses operation requests on the shared cache from the service processing units and the main control unit. As to the operation requests for writing data into a same space of the shared cache, the shared cache unit writes the data of the operation requests into the shared cache space in a mutual exclusion manner to implement mutual exclusion sharing of a cache. As to the operation requests for reading data from a same space of the shared cache, the shared cache unit reads the data of the operation requests from the space at the same time to implement simultaneous sharing of the cache.

The step of writing the data of the operation requests into the shared cache space in the mutual exclusion manner to implement the mutual exclusion sharing of a cache includes: sequencing according to a pre-defined order the operation requests for writing data; when one of the operation requests writes data into the shared cache space, forbidding other operation requests from writing into or reading from the same shared cache space; and after a former operation request finishes its writing operation, allowing a subsequent operation request to perform writing or reading operations.

The step of forbidding other operation requests from writing into or reading from the same shared cache space includes: configuring a writing flag for the shared cache space, and after the writing operation finishes, releasing or changing the writing flag so as to allow a subsequent operation request to write into or read from the shared cache space.

In particular, the step of writing the data of different operation requests into the shared cache space in the mutual exclusion manner further includes: after receiving a writing request for writing data into the shared cache space, if the data to be written is not received within a pre-defined period of time, returning writing failure information and proceeding with the writing and reading operations of other operation requests.

The step of reading the data from the shared cache space for the operation requests to implement the simultaneous sharing of the shared cache space includes: reading data from the shared cache space simultaneously according to the operation requests and forbidding other operation requests from writing into the shared cache space; and after the reading operation finishes, allowing writing operations of subsequent operation requests into the shared cache space.

The step of forbidding other operation requests from writing into the same shared cache space includes: configuring a reading flag for the shared cache space; at this time, forbidding writing operations of other operation requests but allowing reading operations of other operation requests; after the reading operations finish, releasing or changing the reading flag so as to allow writing operations of subsequent operation requests into the shared cache space.

As can be seen, the embodiments of the present invention can ensure the consistency of the operation data among all the service processing units through identifying the operation requests and through implementing the mutual exclusion writing and the simultaneous reading.

In addition, the operation requests on the shared cache further include a space allocation request and a space releasing request.

After a space allocation request is received and parsed, a space allocation operation is performed to ensure further writing and reading operations. Specifically a space is allocated according to the space allocation request, and the allocated space is initialized. The space allocation request is issued to the shared cache through the following: each service processing unit determines whether a service is related to an allocated space, if the service is related to an allocated space, each service processing unit issues a space operation request to the shared cache to perform writing and reading operations; otherwise, each service processing unit issues the space allocation request to the shared cache.

After a space releasing request is received and parsed, a space is released to ensure the space allocation of a subsequent operation request. In particular, a space is released according to the space releasing request. Further, the space releasing request is issued to the shared cache through the following: each service processing unit reports a space releasing request to the main control unit; the main control unit determines whether all the service processing units related to the space report the space releasing requests respectively, if all the service processing units related to the space report the space releasing requests respectively, the space releasing request is issued to the shared cache; otherwise, the main control unit keeps on monitoring the space releasing requests of the service processing units.

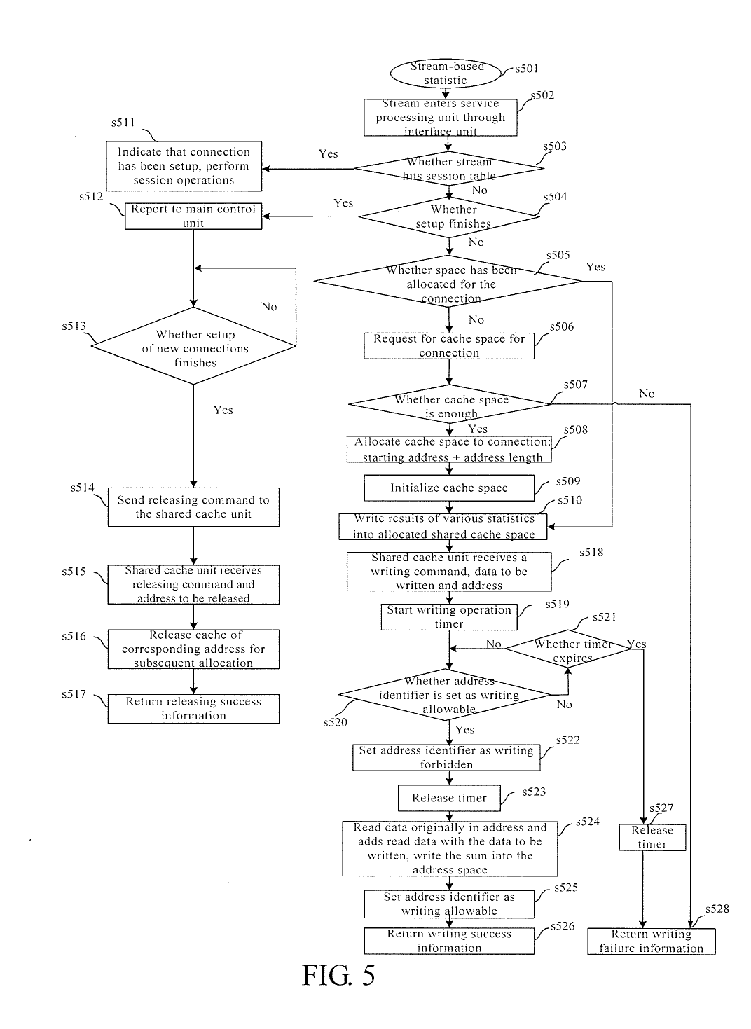

FIG. 5 shows a cache sharing method according to an embodiment of the present invention. This embodiment is based on attack statistic application and includes the following Steps:

Step s501: A service processing unit starts a stream-based statistic.

Step s502: A stream enters the service processing unit through an interface unit.

Step s503: The service processing unit determines whether the stream hits a session table, i.e. compares identifiers in the stream with parameters pre-stored in the session table, if the stream hits the session table, it indicates that the packet is a normal packet, Step s511 is performed; otherwise, it indicates that the packet may be an attack packet, Step s504 is performed to further determine whether the packet is an attack packet.

Step s504: The service processing unit sets up a new connection and determines whether the setup of the new connection finishes; if the setup finishes, it indicates that the packet is a normal packet, Step s512 is performed; otherwise, it indicates that the packet is an attack packet and Step s505 is performed.

The above Steps s501 to s504 are to determine whether a stream is an attack stream. After determining that the stream is an attack stream, Steps s505 to s511 will be performed to collect statistics of parameters of the attack stream and store the collected statistics in the shared cache unit.

Step s505: The service processing unit determines whether a space in the cache has been allocated to the connection, if the space has been allocated, Step s510 is performed; otherwise, Step s506 is performed.

Step s506: The service processing unit requests a cache space for the connection.

Step s507: The service processing unit determines whether the cache space is enough; if not enough, Step s528 is performed; otherwise, Step s508 is performed.

Step s508: The service processing unit allocates the cache space to the connection, wherein the cache space includes a starting address and an address length of the cache.

Step s509: The service processing unit initializes the cache space, i.e., clears the cache space.

Step s510: The service processing unit writes counts of various statistics into the allocated shared cache space and Step s518 is performed.

Step s511: The connection has been set up and the service processing unit performs session operations.

Step s512: The service processing unit reports to the main control unit and Step s513 is performed.

Step s513: The main control unit detects whether setup of new connections of all service processing units related to the connection are finished; if not, the main control unit keeps on detecting; otherwise, proceeds to Step s514.

Step s514: The main control unit sends a releasing command to the shared cache unit.

Step s515: The shared cache unit receives the releasing command and an address to be released.

Step s516: The shared cache unit releases the cache corresponding to the address for re-allocation.

Step s517: The shared cache unit returns releasing success information to the main control unit.

The above Steps s512 to s517 are to release, after determining that there is no attack packet, the corresponding shared cache for storing other data.

Step s518: The shared cache unit receives a writing command, data to be written and an address from the service processing unit.

Step s519: The shared cache unit starts a writing operation timer.

Step s520: The shared cache unit determines whether an address identifier is set as writing allowable, if yes, proceed to Step s522; otherwise, proceed to Step s521.

Step s521: The shared cache unit deter lines whether the timer expires; if the timer does not expire, proceed to Step s520; if the timer expires, proceed to Step s527.

Step s522: The shared cache unit sets the address identifier as writing forbidden.

Step s523: The shared cache unit releases the timer.

Step s524: The shared cache unit reads data originally in the address and adds the read data with the data to be written, then writes the sum into the address space.

Step s525: The shared cache unit sets the address identifier as writing allowable.

Step s526: The shared cache unit returns writing success information to the service processing unit.

Step s527: The shared cache unit releases the timer.

Step s528: The shared cache unit returns writing failure information to the service processing unit.

The above Steps s518 to s528 describe a procedure of writing statistic data into the shared data unit, and describe how to use the mutual exclusion scheme in the embodiments of the present for ensuring the consistency of data operations in detail.

In this embodiment, Steps s501 to s512 relate to processing operations of the service processing unit. Steps s513 to s514 relate to processing operations of the main control unit. And Steps s515 to s528 relate to processing operations of the shared cache unit. Firstly, when a new connection is set up, a shared cache space is allocated for the connection. The main control unit and the service processing units may request a shared cache space independently. After the setup of the connection finishes, the cache space corresponding to the connection may be released and may be released only by the main control unit.

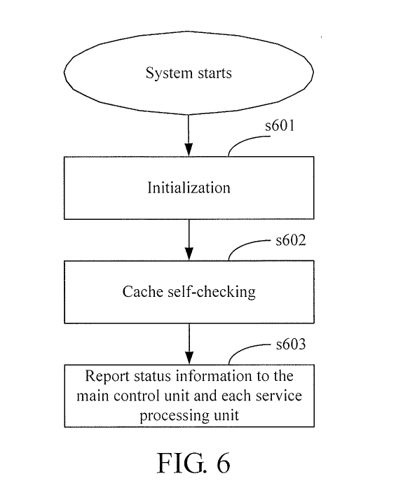

In the embodiments of the present invention, a flag is configured for each allocated cache space. When the flag is set as busy, it indicates that a unit is operating the cache space and other units should wait, so as to ensure data consistency. However, in a reading operation, the mutual exclusion is not required. Therefore, a plurality of units may read from the shared cache space simultaneously, which ensures the data reading speed and ensures that the data are processed in real time. Before collecting the statistics, system initialization is required. As shown in FIG. 6, the system initialization includes the following:

s601: The system starts and initialization is performed.

s602: The shared cache unit performs self-checking.

s603: The shared cache unit reports status information to the main control unit and the service processing units. The status information includes: a total cache space, starting and ending addresses; an available cache space, starting and ending addresses; an unavailable cache space, starting and ending addresses. The initialization finishes after the status information is reported.

In the above embodiments, the cache sharing method ensures the consistency of the operation data through configuring a shared cache. Furthermore, the cache sharing method provided by the embodiments of the present invention can ensure high-speed exchange of the shared data among the service processing units and can thus realize high-speed data sharing.

In particular, the following will be performed after the shared cache unit receives and parses a shared space allocation request:
allocate a shared space, and provide each service processing unit in one cluster with an authority for operating the shared space; the authority includes a reading authority and a writing authority;
a service processing unit requesting the shared space obtains the reading/writing authority, writes data as well as an address of a target recipient in the cluster in the shared space;
after the writing operation finishes, release the reading/writing authority provided for the service processing unit and inform the target recipient to read from the shared space.

In order to avoid deadlock, after the shared space is allocated, the shared space may be released if the shared space is not visited within a pre-defined period of time.

In addition, in order to ensure utilization efficiency of the shared space, after the shared space is allocated, the shared space is released according to a releasing request of the service processing unit requesting the shared space.

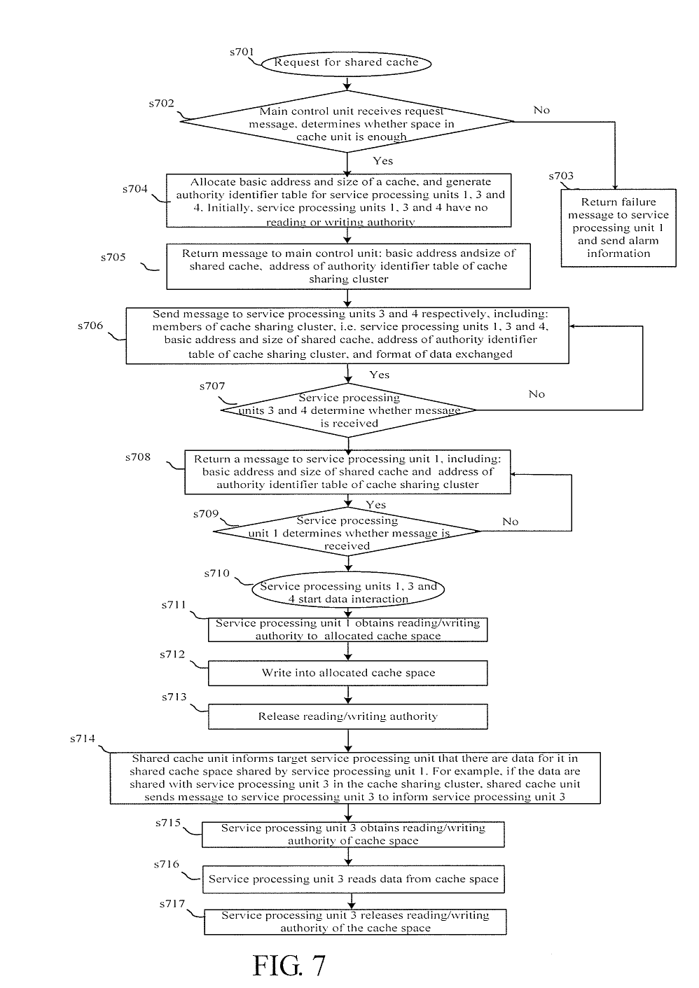

FIG. 7 is a flowchart illustrating an implementation of high-speed data sharing. The utilization of the shared cache unit is not fixed. Instead, the shared cache unit is requested according to requirements. For example, if a service processing unit 1 initiates a data visit to service processing units 3 and 4, it request the main control unit for a shared cache unit after defining the size of the required cache space and the format of exchanged data. The implementation includes the following:

Step s701: Request a shared cache. Suppose that the service processing units 1, 3 and 4 require high-speed data exchange. The service processing unit 1 sends a request message to the main control unit. The request message includes: members of one cache sharing cluster, e.g. the service processing units 1, 3 and 4, the size of the shared cache and the format of the exchanged data.

Step s702: The main control unit receives the request message, determines whether the shared cache unit has enough space; if enough, proceed to Step s704; otherwise, proceed to Step s703.

Step s703: Return a failure message to the service processing unit 1 and send alarm information.

Step s704: The shared cache unit allocates a basis address and the size of a shared cache, and generates an authority identifier table for the service processing units 1, 3 and 4. Initially, the service processing units 1, 3 and 4 have no read or write authority.

Step s705: The shared cache unit returns a message to the main control unit. The message includes the basic address and the size of the shared cache and an address of the authority identifier table of the cache sharing cluster.

The above Steps s701 to s705 relate to a procedure in which the service processing unit 1 initiating a cache sharing operation obtains the corresponding cache space.

Step s706: The main control unit sends a message to the service processing units 3 and 4 respectively. The message includes: members of the cache sharing cluster, i.e. the service processing units 1, 3 and 4, the basic address and the size of the shared cache, the address of the authority identifier table of the cache sharing cluster, and the format of the data exchanged.

Step s707: The service processing units 3 and 4 determine whether the message is received; if the message is not received, proceed to Step s706 and inform the main control unit to re-transmit the message; otherwise, proceed to Step s708.

The above Steps s706 to s707 relate to a procedure in which the other service processing units in the cache sharing cluster obtains the corresponding cache space.

Step s708: The main control unit returns a message to the service processing unit 1. The message includes: the basic address and the size of the shared cache and the address of the authority identifier table of the cache sharing cluster.

Step s709: The service processing unit 1 determines whether the message is received from the main control unit; if the message is not received, proceed to Step s708 to inform the main control unit to re-transmit the message; otherwise, proceed to Step s710.

Step s710: The service processing units 1, 3 and 4 start data exchange.

Step s711: The service processing unit 1 obtains the reading/writing authority to the allocated cache space.

Step s712; The service processing unit 1 writes into the allocated cache space.

Step s713: The service processing unit 1 releases the reading/writing authority.

The above Steps s708 to s713 relate to a procedure in which the service processing unit 1 performs reading/writing operations on the shared cache unit.

Step s714: The shared cache unit informs a target service processing unit that the shared cache space has data which the service processing unit 1 will share with the target service processing unit. For example, if the data are shared with the service processing unit 3 in the cache sharing cluster, the shared cache unit sends a message to the service processing unit 3 to inform the service processing unit 3. The data may also be shared with the service processing units 3 and 4 simultaneously. Thus, the shared cache unit sends messages to the service processing units 3 and 4 simultaneously. After obtaining authorities, the service processing units 3 and 4 read the data.

Step s715: The service processing unit 3 obtains the reading/writing authority of the cache space.

Step s716: The service processing unit 3 reads data from the cache space.

Step s717: The service processing unit 3 releases the reading/writing authority of the cache space.

The above Steps s714 to s717 relate to a procedure in which the other service processing units in the cache sharing cluster share the data in the shared cache unit.

The Steps s702, s703, s706 and s708 are processing operations of the main control unit. Steps s704, s705 and s714 are processing operations of the shared cache unit. The other Steps are processing operations of the service processing units.

In the above solution, one service processing unit is allowed to request multiple cache spaces and to exchange data with different service processing units. For example, after successfully requesting a cache space with service processing units 3 and 4, a service processing unit may further request a shared cache space with service processing units 2 and 5. It is even possible to request multiple cache spaces within one cluster (including the service processing units 1, 3 and 4, or service processing units 1, 2 and 5) for interaction of different kinds of data.

Because at least two members share one cache, when writing data into the allocated cache space, the service processing unit 1 needs to write a target recipient within one cluster, i.e. the service processing unit 3 or 4, or the service processing units 3 and 4 simultaneously. After the service processing unit 1 finishes the data writing and releases the reading/writing authority of the cache space, the cache controller is required to transmit a message to the recipient instead of adopting a polling manner, so that the data exchange efficiency is further improved.

After used, the shared cache space should be released according to a principle that the service processing unit which requests for the shared cache space should release the shared cache space. For example, if the service processing unit 1 requests a shared cache space with the service processing units 3 and 4, after the shared cache space is used, the service processing unit 1 should send a release message to the main control unit. After receiving the release message, the main control unit sends a release command to other service processing units sharing the shared cache space, and simultaneously requires the shared cache unit to release the shared cache space. The shared cache unit maintains each allocated cache space by itself. If an allocated cache space is not visited within a pre-defined period of time, the shared cache unit ages and recycles the allocated cache space, and informs the service processing units using the allocated cache space as well as the main control unit.

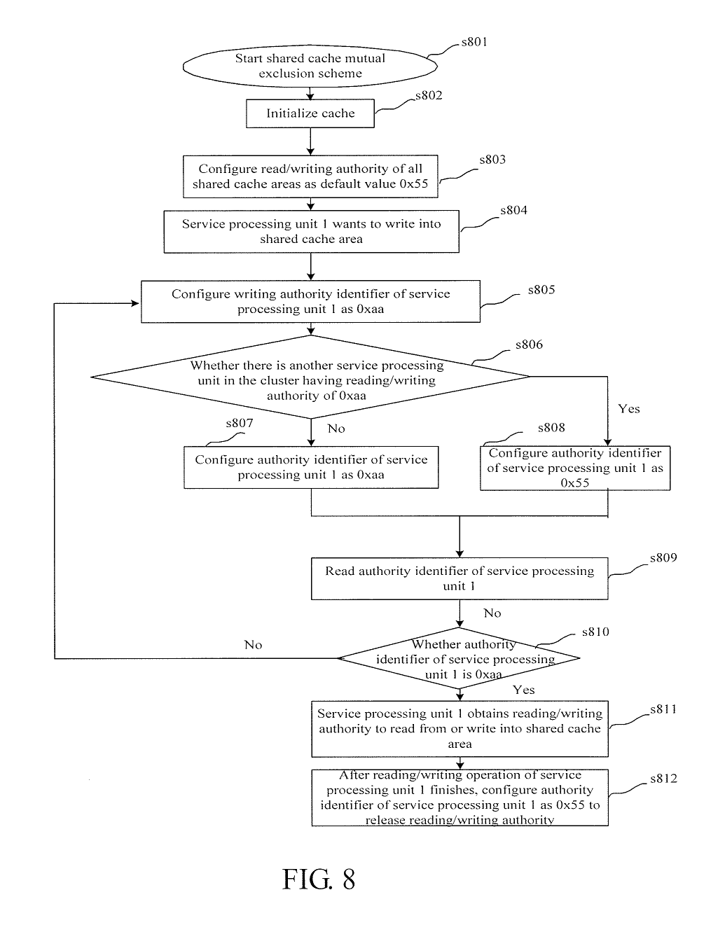

Certainly, the above shared cache space also follows a scheme of mutual exclusion writing and simultaneous reading. As shown in FIG. 8, the mutual exclusion writing and simultaneous reading include the following:

Step s801: Start the mutual exclusion scheme of the shared cache. Configure a reading/writing flag for each service processing unit sharing a cache space (in this embodiment, 0x55 denotes no reading/writing authority, and 0xaa denotes having reading/writing authority, as shown in table 1; in practical applications, the values denoting the reading/writing authority may be configured randomly). Before any reading/writing operation, the reading/writing authority must be obtained firstly to ensure data consistency in the cache. When the reading/writing operation finishes, the reading/writing authority should be released; otherwise, deadlock may arise and data cannot be shared.

TABLE 1

| | Service processing | | |
|---|---|---|---|
| | unit | | |
| | 1 | 3 | 4 |
| Authority identifier | 0x55 | 0x55 | 0x55 |

Step s802: Initialize the cache.

Step s803: Configure the read/writing authorities of all shared cache areas as default values 0x55.

Step s804: The service processing unit 1 desires to write into a shared cache area.

Step s805: The reading/writing flag of the service processing unit 1 is configured as 0xaa.

Step s806: The shared cache unit determines whether another service processing unit in same cluster as the service processing unit 1 has a reading/writing flag=0xaa; if another service processing unit in the same cluster has the reading/writing flag=0xaa, proceed to Step s808; otherwise, proceed to Step s807.

Step s807: Configure the reading/writing flag of the service processing unit 1 as 0xaa, and proceed to Step s809.

Step s808: Configure the reading/writing flag of the service processing unit 1 as 0x55, and proceed to Step s809.

Step s809: Read the reading/writing flag of the service processing unit 1.

Step s810: Determine whether the reading/writing flag of the service processing unit 1 is 0xaa; if the reading/writing flag of the service processing unit 1 is 0xaa, proceed to Step s811; otherwise, proceed to Step s805.

Step s811: The service processing unit 1 has the reading/writing authority and can read from or write into the shared cache area.

Step s812: After finishing the reading/writing operation of the service processing unit 1, configure the reading/writing flag of the service processing unit 1 as 0x55 and release the reading/writing authority to avoid deadlock.

Through the above descriptions of the embodiments, those skilled in the art should know that the present invention may be implemented by software together with a necessary universal hardware platform. Certainly, it is also possible to implement the present invention only by hardware. But more generally, the former implementation manner is preferable. Based on this, the essential part of the technical solution of the present invention or the part contributing to the prior art may be embodied by a software product. The software product is stored in a storage media, including instructions for enabling a computer (such as personal computer, server or network device) to execute methods of the embodiments of the present invention.

In view of the above, embodiments of the present invention also provide cache sharing software, applied to a system including a main control unit and a plurality of service processing units. The main control unit and the plurality of service processing units are connected with a shared cache. The cache sharing software includes instructions to perform the following steps:
receive and parse operation requests on the shared cache;
as to operation requests for writing data into a same space of the shared cache, implement writing operations of the operation requests in a mutual exclusion manner to realize a mutual exclusion sharing of the cache; and
as to operation requests for reading data from the same space of the shared cache, implement reading operations of the operation requests simultaneously to realize simultaneous sharing of the cache.

Embodiments of the present invention also provide a cache sharing system, applied to implementing cache sharing, as shown in FIG. 4 and FIG. 5. The cache sharing system includes a main control unit and a plurality of service processing units, and further includes a shared cache unit respectively connected with the main control unit and the plurality of service processing units.

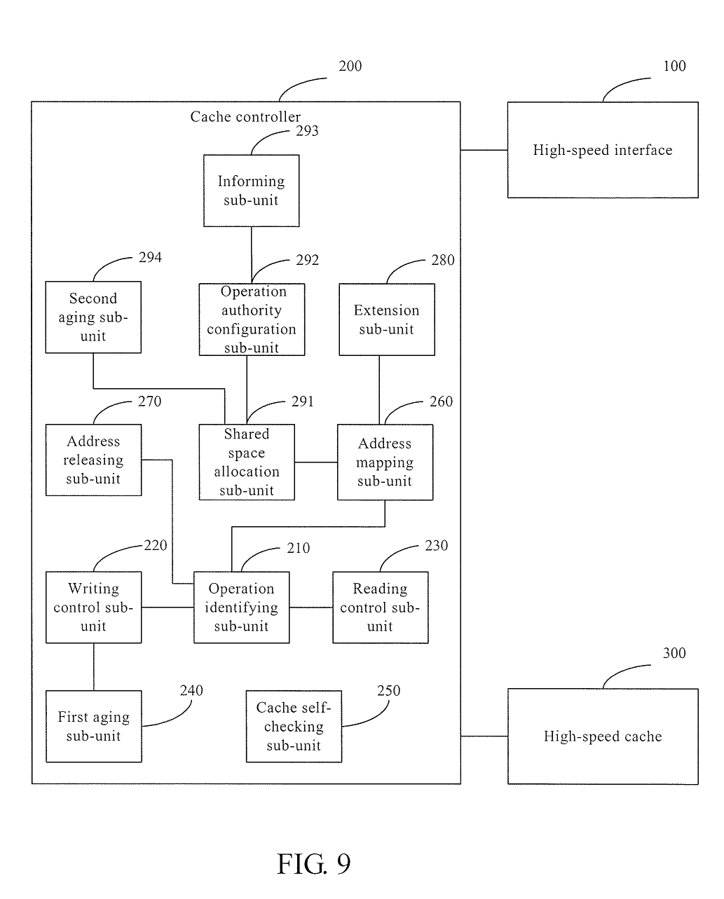

The shared cache unit is shown in FIG. 9. In particular, the shared cache unit includes: a high-speed interface 100, respectively connected with the main control unit and the plurality of service processing units, adapted to receive various operation requests transmitted from the plurality of service processing units to the main control unit, forward data transmitted between the shared cache unit and the service processing units; a high-speed cache 300, adapted to provide a cache space and store data at a high speed; a cache controller 200, connected between the high-speed interface 100 and the high-speed cache 300, adapted to implement cache sharing.

The cache controller 200 specifically includes: an operation identifying sub-unit 210, adapted to parse an operation request on the shared cache; a writing control sub-unit 220, adapted to sequence operation requests for writing into the shared cache according to a pre-defined order, forbid other operation requests from writing into the same space when one operation request is writing into the space, and allow subsequent operation requests to read from or write into the same space after the writing operation of the former operation request finishes; a reading control sub-unit 230, adapted to read data from the space simultaneously according to the operation requests, forbid other operation requests from writing into the same space, and allow subsequent operation requests to write into the space after the reading operation finishes; a first aging sub-unit 240, connected with the writing control sub-unit 220, adapted to age and refresh writing requests of the space; a cache self-checking sub-unit 250, adapted to initialize the high-speed cache 300, and report status information to the main control unit and each service processing unit, wherein the status information includes total spaces, available spaces, unavailable spaces and their corresponding starting and ending addresses; an address mapping sub-unit 260, adapted to implement address mapping and cache space allocation for the high-speed interface 100 and high-speed cache 300 according to a space allocation request received by the operation identifying sub-unit 210; an address releasing sub-unit 270, adapted to release a cache space according to a space releasing request received by the operation identifying sub-unit 210; wherein the space releasing request is issued by the main control unit to the shared cache in case that all the service processing units related to the space have requested releasing the space; an extension sub-unit 280, connected with the address mapping sub-unit 260, adapted to extend an addressing space of the cache address of the high-speed cache 300.

Through the above apparatus, the requirement of scalable sharing of a cache and ensuring consistency of the cache data are met.

Furthermore, the cache controller 200 further includes: a shared space allocation sub-unit 291, connected with the address mapping sub-unit 260, adapted to allocate a shared space to service processing units in a cluster according to a shared space allocation request received by the operation identifying sub-unit 210; an operation authority configuration sub-unit 292, connected with the shared space allocation sub-unit 291, adapted to provide an operation authority to the service processing units for operating the shared space, wherein the operation authority includes a reading authority and a writing authority; the shared space allocation sub-unit 291 is further adapted to take back the operation authority provided to each service processing unit for operating the shared space after the service processing unit's operation to the shared space finishes; an informing sub-unit 293, connected with the operation authority configuration sub-unit 292, adapted to inform, after obtaining an address of a target recipient in the cluster and the writing operation finishes, the target recipient to read the cache space. In addition, in order to avoid deadlock, the cache controller 200 may further include a second aging sub-unit 294, connected with the shared space allocation sub-unit 291, adapted to refresh the shared space regularly.

The foregoing descriptions are only preferred embodiments of this invention and are not for use in limiting the protection scope thereof. Any changes and modifications can be made by those skilled in the art without departing from the spirit of this invention and therefore should be covered within the protection scope as set by the appended claims.

1. A system for implementing cache sharing, comprising: a main controller, a plurality of service processing units, and a shared cache unit connected with the main control unit and the plurality of service processing units respectively;
wherein the main controller transfers control information to the plurality of service processing units through a control channel, and the plurality of the service processing units transfer service data between each other through a service channel; the main controller and the plurality of the service processing units are respectively configured with memories;
the shared cache unit is adapted to implement cache sharing and comprises:
a high-speed interface, respectively connected with the main control unit and the plurality of the service processing units, adapted to receive operation requests on the shared cache unit;
a high-speed cache, adapted to provide a cache space and store data at a high-speed; and
a cache controller, connected between the high-speed interface and the high-speed cache, adapted to: according to the operation requests on the shared cache unit, implement an operation on the high-speed cache to realize the cache sharing.

2. The system of claim 1, wherein the cache controller comprises:
a writing control sub-unit, adapted to forbid other operation requests from reading or writing into the cache space when one of the operation requests for writing writes into the same cache space, and allow a subsequent operation request to read from or write into the same cache space after a writing operation of a former operation request is terminated; and
a reading control sub-unit, adapted to read data from the cache space simultaneously according to each operation request for reading, forbid other operation requests from writing into the same cache space, and allow the subsequent operation request to write into the cache space after operations requests for reading are terminated.

3. The system of claim 1 wherein the cache controller further comprises:
an aging sub-unit, adapted to age and recycle the cache space when the cache space is not visited during a period of time, and adapted to notify the main control unit

4. The system of claim 1, wherein the cache controller comprises:
a cache self-checking sub-unit, adapted to initialize the high-speed cache, report status information to the main control unit, or to both the main control unit and each service processing unit;
wherein the status information comprises a total space, an available space of the high-speed cache and corresponding starting and ending addresses of the total space and the available space respectively.

5. The system of claim 1, wherein the cache controller further comprises:
an address mapping sub-unit, adapted to perform address mapping for the high-speed interface and the high-speed cache according to a space allocation request received, and allocate the cache space; and
an address releasing sub-unit, adapted to release a space according to a space releasing request received, wherein the space releasing request is issued by the main control unit to the shared cache unit in case that all service processing units related to the cache space have requested for releasing the space.

6. The system of claim 5, wherein the cache controller further comprises: an extension sub-unit, connected with the address mapping sub-unit, adapted to extend a addressing space of a cache address in the high-speed cache.

7. A method for implementing cache sharing based on the system of claim 1, wherein a first service processing unit initiates a message for allocating a cache space, the message comprising the first service processing unit and a second service processing unit which are members sharing the cache space and a size of the cache space;
after receiving the message, issuing, by the main controller to the shared cache unit, a command of allocating the cache space;
after receiving the command, transmitting, by the shared cache unit to the main controller, information of the cache space and reading and writing authorities of the members sharing the cache space;
obtaining, by the first service processing unit, a writing authority allocated to itself, writing data to be written into the cache space, and releasing the writing authority after finishing writing;
obtaining, by the second service processing unit, a reading authority allocated to itself, reading data from the cache space, and releasing the reading authority after finishing reading.

8. The method of claim 7, further comprising:
when writing by the first service processing unit the data to be written into the cache space, writing, into the cache space by the first service processing unit, information of the second service processing unit which will receive the data; and
notifying, by the cache controller, the second service processing unit to obtain the data from the cache space.

9. The method of claim 7, further comprising:
after the first service processing unit and the second processing unit finish operations on the cache space, transmitting, by the first service processing unit, a releasing message to the main controller; and instructing, by the main controller, the shared cache unit to release the cache space.

10. A method for implementing cache sharing based on the system of claim 1, comprising:
when a writing request is writing into a cache space, forbidding other requests from reading from or writing into the cache space, and after a former writing request is terminated, allowing a subsequent request to read from or write into the cache space;
when a reading request is reading from the cache space, reading data from the cache space simultaneously according to each reading request, forbidding other requests from writing into the same cache space;
allowing a subsequent request to write into the cache space after reading operations corresponding to reading requests are terminated.

11. The method of claim 10, wherein the forbidding the other requests from reading from or writing into the cache space comprises:
configuring a writing flag for the cache space, and after the writing request is terminated, releasing or changing the writing flag to allow the subsequent request to write into or read from the cache space.

12. The method of claim 10, further comprising:
before reading from or writing into the cache space, performing, by the shared cache unit, self-checking; after finishing the self-checking, reporting status information to the main control unit, or to both the main control unit and each service processing unit.

13. The method of claim 11, further comprising:
releasing the cache space according to a space releasing request from the main controller;
wherein the space releasing request is issued to a shared cache through steps of:
reporting, by each service processing unit, a space releasing request to the main control unit;
determining, by the main control unit, whether all service processing units related to the cache space have reported the space releasing request;
if all the service processing units related to the space have reported the space releasing request, issuing, by the main control unit, the space releasing request to the shared cache; otherwise, keeping on monitoring space releasing requests of all the service processing units related to the cache space.
